(19) United States
(12) Patent Application Publication
(10) Pub. No.: US 2007/0294934 A1
(43) Pub. Date: Dec. 27, 2007

(54) SAFESLIDE BOBBER APPARATUS

(75) Inventor: James Andrew Myers, McKinney, TX (US)

Correspondence Address: James Andrew Myers, 2832 Rush Creek Rd., McKinney, TX, 75070, US

(73) Assignee: James Myers

(21) Appl. No.: 11/800,439

(22) Filed: May 4, 2007

Related U.S. Application Data
(63) Continuation-in-part of application No. 11/474,203, filed on Jun. 26, 2006, now abandoned.

(51) Int. Cl. A01K 93/00

(52) U.S. Cl. 43/44.9; 43/41

(57) ABSTRACT

A safe fishing bobber is disclosed having a plastic, hollow shield holding the hook and bait inside to protect against accidental contact with the hook, preventing snags on water structures and protecting the bait. An attached stem extends vertically from the shield. Fishermen use floats of various colors, shapes and styles for various fishing methods, buoyancy requirements and personal preference. This safe bobber design allows the fisherman to choose from varieties of floats and easily apply one onto the stem. The float is above water when in use, while the shield remains submerged. The fishing depth is set with a slide able stop member placed above the bobber on the fishing line, which stops at the tip of the stem when this depth is reached. The bait drops into the water to the desired depth. When retrieved, the hook returns into the shield as guided by the line through the stem.

### REFERENCE TO RELATED APPLICATIONS

This continuation in part application claims the priority of U.S. patent application Ser. No. 11/474,203 filed on Jun. 26, 2006, entitled “SAFESLIDE BOBBER APPARATUS”.

### TECHNICAL FIELD

The present invention relates to fishing hooks, lines, sinkers and related fishing lures and rigs.

### BACKGROUND OF THE INVENTION

A variety of fishing bobbers are well known in the art. For example, U.S. Pat. No. 4,075,777, No. 2,607,152, No. 2,910,798, No. 2,629,198, No. 4,060,925, No. 3,063,187, and many others attempt to prevent damage to bait, such as a minnow, when cast upon the water by providing a protective tube in which the bait is placed. At the same time, providing an attached float member to indicate a fish has grabbed a baited hook. Another bite indicator, such as U.S. Patent Application 20050120615, U.S. Pat. Nos. 6,519,894 and 3,686,787 shield the hook from danger and snags while casting and retrieving the hook. U.S. Pat. No. 2,292,743, No. 4,610,104, No. 4,534,127 and German Patent No. 19836255 provide protection for the bait when cast upon the water and provide protection from hook danger when casting and from snagging on water structures while retrieving from the water.
While developing, making and using the preferred embodiment, it is found that a bite indicator in which provides a shield from the dangers of casting a fishing hook, prevents snagging on water substances, such as brush, logs, moss and trees, when casting and retrieving the hook. At the same time, this bobber protects the bait, such as a minnow, from damage when casting and impacting the water. With such a device, a fine balance must be achieved. The size, shape, placement and buoyancy of the float and/or air chamber, in conjunction with the size, weight and physical properties of the tube structure, which provides the protection for the hook and bait, must be closely balanced when in the water to achieve the desired buoyancy and vertical position of the device. When more buoyancy is added, the lesser the desired vertical positioning of the device and when more size and weight of the protecting tube is added, the lesser the desired buoyancy. Adding various sizes and weights of fishing rigs to the device further unbalances the desired buoyancy and vertical positioning and efficiency of such a device. The current invention to be described will show many changes and differing embodiment features, which provides, maintains and adjusts this desired balance. The description and illustrations will further explain why and how this desired balance is met. It will also show other advantageous features which all enhance the efficiency and use of a bite indicator of this type.

### SUMMARY OF THE INVENTION

The present fishing bobber efficiently provides protection from the hook when being cast. It protects the bait from damage when casting and when hitting the water. It further prevents snags when casting or when retrieving the hook and bait back from the water. The shield of the fishing bobber protects the hook and holds the size and weight of the fishing rig. The shield is completely submerged when in the water. The shields larger, lowermost, open ended area is provided for the hook and bait or lure to be loosely suspended inside, as to not get lodged inside the shield. And for the hook to not get caught on the edge of the shield when drawn back up into the shield from the water. The shield quickly fills with water when cast upon a body of water, allowing the device to quickly assume and maintain a stable, vertical position when submerged. All undesired air, which forms in the shield when the bite indicator hits the water, is quickly and efficiently funneled into and out of the smaller, uppermost, closed ended area of the shield through vent slots, also located in the closed area of the shield. These slots, in conjunction with the smaller circumference of the upper closed area, also provide a gripping handle to hold onto after catching a fish. A narrow stem is attached and extends vertically from the center area of the closed end of the shield. The stem provides a passageway for the fishing line into the shield. The stem also holds the float. Interchangeable floats are easily applied onto and removed off of the stem. The fisherman can choose and interchange a float from a variety of shapes, styles, colors and buoyancies for various types of fishing, various weights and sizes of rigs, fishing conditions or for personal preference. This device provides the luxury of float choice with one shield. When inserted onto the stem, the float will rest on the outside, top of the shield and circumjacent the stem. The stem is a separation point between the weight of the shield and rig from the buoyancy of the interchangeable float. This fishing bobber, as well as many other types of bite indicators, uses a well known method called slip bobber fishing. A lightweight slide able stop member to set the fishing depth is attached to the fishing line and located above the device. The fishing line is inserted into the stem and fed down a narrow passageway and into the shield. A second fishing line insertion point into the shield is provided in the closed area of the shield for ultra light rigs, in which drop easier into the water when submerged. A fixed stop member, such as a fishing sinker, is attached onto the line and adjusted as such that the hook and bait or lure attached to the end of the fishing line is suspended inside the larger open area of the shield. The fixed stop member will rest against fishing line entry hole into the shield. When in the water, the slide able stop member will be located at the tip of the stem. The weight, hook and bait or lure will be in the water at the desired fishing depth.

### BRIEF DESCRIPTION OF THE DRAWINGS

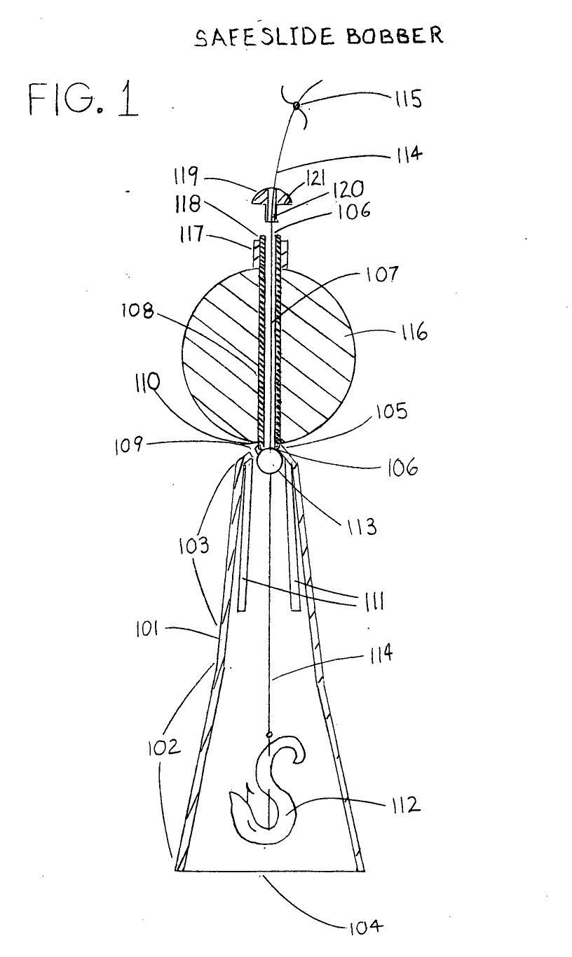

Sheet 1, FIG. 1 is a cross sectional view of the bobber with the float and securing sleeve applied. The fishing rig and line is shown applied through out the bobber.

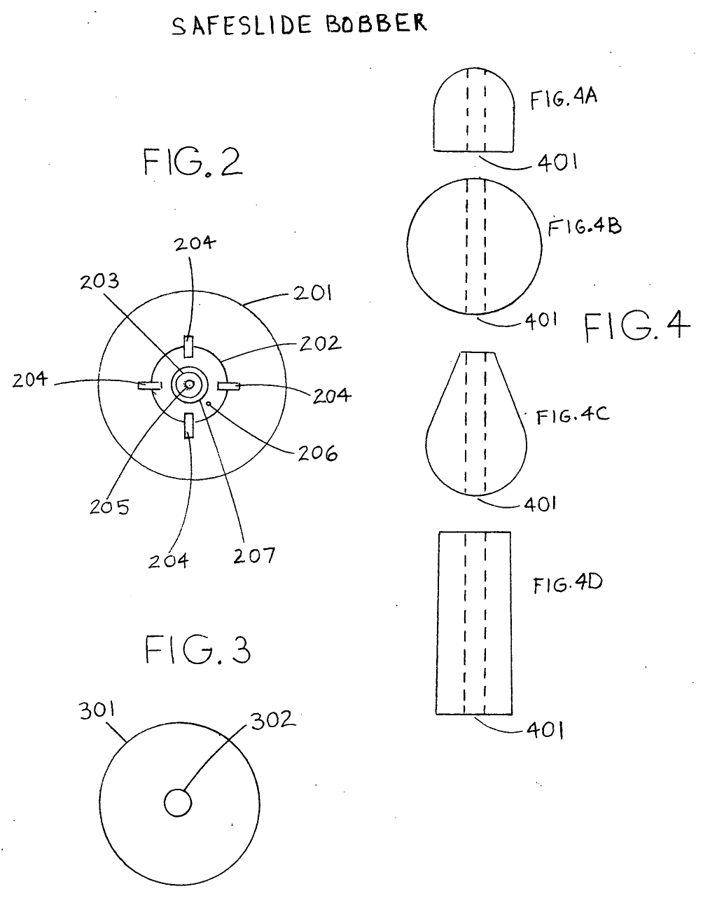

Sheet 2, FIG. 2 is a top down view of the bobber showing outside dimensions of the shield hook and bait area 201, air release chamber 202, stem 203, vents slots 204, fishing line entry into the stem 205, second, optional fish line entry 206 and float securing sleeve 207.

Sheet 2, FIG. 3 is top down view of an interchangeable float's outside diameter 301 and a bore through the float 302.

Sheet 2, FIG. 4A-D is a side view of interchangeable float styles with center bore 401.

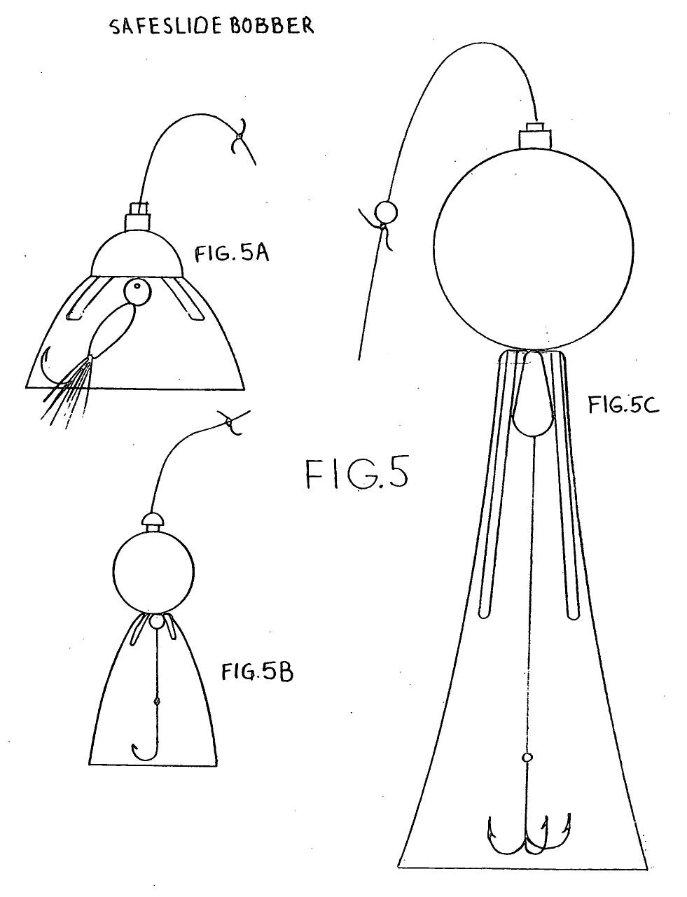

Sheet 3, FIG. 5. (FIG. 5A, 5B, SC) is a side view of three shapes of the shield with an interchangeable float and fishing rig applied.

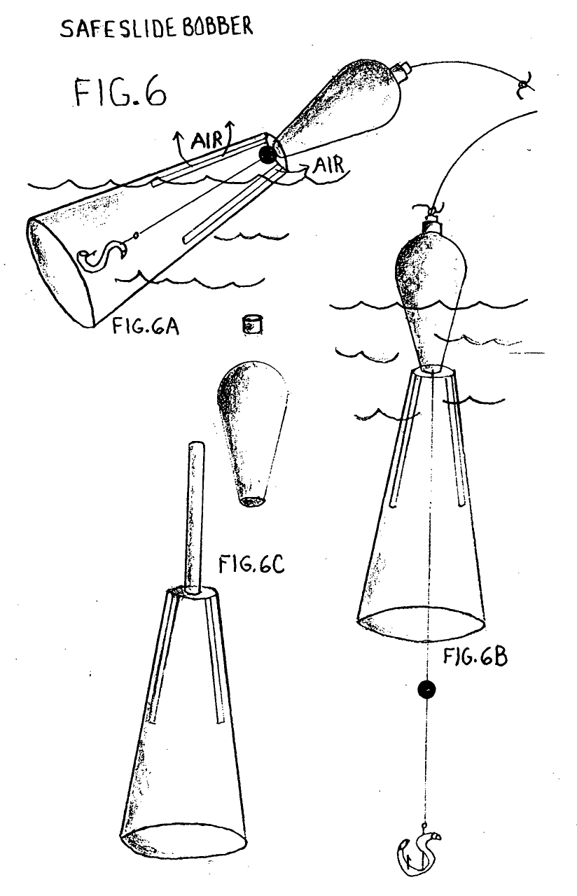

Sheet 4, FIG. 6 is a perspective view of the bobber. FIG. 6A is the bobber hitting the water and releasing trapped air. FIG. 6B is the bobber in the water with the fishing hook and bait released. FIG. 6C shows the bobber with the float and float securing member removed from the shield.

### DESCRIPTION

As seen in FIG. 1, the present invention comprises a fishing bobber with a shield 101. The shield 101 shall be made of a light weight, clear plastic and/or tinted in various colors while retaining enough transparency to be able to see the hook and bait 112 and fixed line stop 113 inside the shield 101. The shield 101 shall be of a thin walled and hollow construction. The plastic shall be self submersible and have a specific gravity equal to or greater than that of water (1.0). When made, the two distinct areas of the shield 101, the hook and bait area 102 and the air release chamber 103 can be dimensionally expanded or contracted independently or together when formed in various combinations and sizes, to be suitably adapted to be used with differing sizes of fishing rigs for various types of fishing as seen in FIG. 5. The shield 101 portion will then take on a distinct look of a horn shape, funnel shape or bell shape as seen in FIGS. 5A, 5B and 5C. A preferred size shield 101 for use with standard freshwater fishing, such as bluegill, bass or catfish will be described below and illustrated in FIG. 1 and look like that of a horn shape. The lower most portion 102 of the shield 101 is the hook and bait area 102. The hook and bait area 102 is open 104 at its largest, lowermost portion and is formed like those of the larger bottom half of a hollow cone. The upper most portion of the shield 101 is the air release chamber 103 and is somewhat of a cylindrical shape. The air release chamber 103 has an overall size and capacity which is less than that of the larger hook and bait area 102. The upper most area 105 of the air release chamber 103 is closed ended, other than an opening 106, which leads to the fishing line 114 passageway 107 of a stem portion 108. A small hole 109, formed through the closed end 105 of the shield 101 near or around the stem 108 provides a second fish line passageway. The very top closed ended portion of the air release chamber 105 is also optionally rounded or tapered. The formation of this area 105 has shown not to be critical in the operation of the device as long as it has a diameter large enough as to not allow a fixed line stop 113 to get lodged in this area 103. The air release chamber 103 is the area of the shield 101 which contains vent slots 111. The thin outer walls of the hook and bait area 102 and the air release chamber 103 taper together to form the hollow, horn shaped shield 101. The lower hook and bait area 102 of the shield 101 is of a larger diameter and capacity to allow a fish hook and bait or lure 112 of the rig to be suspended loosely in this area. This allows for a space to exist between and around the hook and bait or lure 112 of the rig and the walls of the hook and bait area 102 as to not allow the hook and bait 112 of the rig to get lodged in this area 103. A fixed line stop 113, such as a fishing weight, leader or bead is adjusted and fixed to the fishing line 114 at the point above the hook and bait 112 as to keep the hook and bait 112 suspended in the desired location of the hook and bait area 102. The fixed line stop 113 is of a larger size than that of the opening 106, which leads to the fish line passageway 107 of the stem 108 and larger than an optional fishing line entry hole 109. This prevents the fixed line stop 113 from being passed up into the fishing line passageway 107 of the stem 108 or through the hole 109. The larger, open, lower most diameter 104 of the hook and bait area 102 lessens the occurrence that the hook 112 of the fishing rig will not get caught on the edge of the lower circumference of the hook and bait area 102, when it is drawn up into the shield 101. The water pressure around the larger capacity, hook and bait area 102, allows the bite indicator to maintain and hold the desired vertical position when in the water, with an optional range of float buoyancy. The impact of the shield 101 hitting the water creates air pockets to form in various inside areas of the shield 101, thus adding undesired buoyancy throughout the shield 101 and hindering the desired vertical position of the bite indicator. The water and air, which enters the larger capacity and opening 104 of the hook and bait area 102, when it is cast upon the water, is quickly funneled into the smaller capacity air release chamber 103 of the shield 101. All of the air is released from the shield 101 as it simultaneously fills completely with water, in turn, allowing the bite indicator to quickly assume the desired, stabilized vertical position in the water. The air release is efficiently provided through vent slots 111 which are formed in the air release chamber 103. The vent slots 111 extend vertically straight down or at an angle from and around the top closed end portion 105 of the air release chamber 103. The length of the vent slots shall extend from, but not into the stem 108, as to not interfere with the fishing line 114 or fixed line stop 113 and down towards, but not to extend into the hook and bait area 102 of the shield 101, to not interfere with the hook and bait 112. The slotted vents 111 are to be formed of a narrow width to eliminate the occurrence of the fixed line stop 113 being passed through the vent slots 111 to the outside wall of the air release chamber 103. The number of vent slots 111 formed shall be unlimited and will depend on the circumference and size of the air release chamber 103. The long, narrow characteristic and location of these vent slots 111 provide efficient air release from the entire shield 101. These elongated vent slots 111 along with the smaller circumference of the air release chamber 103 provide a non-slip gripping handle which allows for easier handling of a caught fish. The larger hook and bait area 102 in conjunction with the smaller air release chamber 103, which together form the shield 101, efficiently allows the fishing bobber to quickly assume the desired vertical position when cast into the water and simultaneously deliver the hook and bait 112 and fixed line stop 113 straight down into the water. The stem portion 108 of the shield 101 provides a separation point 110 between the buoyancy of the float 116 and the submersible, combined weight of the hook and bait 112, fixed line stop 113 and the shield 101. The separation between the stem 108 and shield 101 provides the fisherman an easy method of adding a larger float 116 to provide more buoyancy when a rig of a larger weight is added, while using the same shield 101 with attached stem 108. The stem 108 furthermore provides the fisherman an easy, quick method to interchange floats 116 of various buoyancies and styles. The stem 108 is a long, narrow and tube like and extends vertically from the top of the outside, center axis 110 of the air release chamber 103. The stem 108 shall be made of a rigid plastic or other rigid material The outside diameter of the stem 108 is much smaller than that of the air release chamber 103 and the hook and bait area 102 of the shield 101. The stem 108 is of just enough outside diameter to provide a rigid wall thickness for attaching and detaching the interchangeable float 116. The inside, center bore 107 of the stem 108 shall be of a diameter large enough to provide a smooth, frictionless passageway for a fishing line 114 to pass freely back and forth along the inside, vertical length of the stem 108. The diameter of the entry hole 106 at the tip of the stem 108 is of a diameter in which a slide able line stop 115, attached on the fishing line 114 above the fishing bobber, will not pass into the top entry hole 106 of the stem 108. The diameter of the opening 106, where the stem 108 meets the air release chamber 103 will be as such that it is larger or equal to that of the fish line passageway 107 and small enough to not allow the fixed stop member 113 such as a fishing weight, leader or bead not to be allowed to pass up into the fishing line passageway 107 of the stem 108. The stem 108 shall extend from and slightly into the junction where stem 108 meets the top centermost axis 110 of the air release chamber 103, and vertically to a length of no longer than the combined total vertical length of the shield 101. The stem 108 length shall be long enough to pass completely through the bore (see FIG. 4-401) of the largest interchangeable float 116 provided for a shield 101, a small plastic sleeve 117, and a slight protrusion 118 beyond the sleeve 117. The stem 108 allows the fisherman to easily change the float 116 in seconds by hand using the same shield 101 and stem 108. It must be noted that in manufacture, that the stem 108 can be attached to the shield 101 by various methods including heat bonding, glue bonding, snap fit or a compressed fitting to name a few. The stem can be molded into the shield as one piece for larger models. But due to injection mold limitations a smaller size fishing bobber of this type may require the stem 108 to be attached separately as described. The interchangeable floats 116 can be of many differing shapes, sizes, colors, styles, materials and buoyancy. These floats (see FIG. 4) are changed by fisherman for color preference, identification purposes when several fishermen are in close proximity, for different types of sport fishing and for adjusted buoyancy when using various size rigs. These floats (FIG. 4) will all have one thing in common in that they all have a bore (FIG. 4-401), which extends completely through the centermost axis of each of the floats (FIG. 4A-4D). The bore diameter (FIG. 4-401) is the same diameter of the outside diameter of the stem 108 when the float 116 is made of a pliable material such as expandable polystyrene or other closed cell foams. This bore will be slightly larger for floats made of a hard material for ease of changeability. When the float 116 is applied, it is simply slid onto the stem 108 and rests on the top, of the outside area 105 of the air release chamber 103. A small plastic sleeve 117 is placed onto the stem 108, behind and on top of the float 116, to provide a means to secure the float 116. The small sleeve 117 is made of a tubular, thin walled, flexible, buoyant plastic such as polyethylene. It is made in various colors as desired and shall have an inside diameter the same as the bore 401 of the float 116. The sleeve 117 shall have an outside diameter more than that of the stem 108 and its height is generally close to that of its outside diameter. The float securing member 117 can also comprise of a stem insert 119. The insert 119 is made of a rigid plastic and comprises a small tubular stem with a center bore 120 through its length. The outside diameter of the insert 119 is the same as the inside diameter of the opening to the stem 106. The insert 119 has annularly flared flange 121 on its top which extends beyond the outside diameter of the tip of the stem 118. This flange will not allow the float 116 to slip off of the stem 108. The center bore diameter 120 of the insert 119 also acts as the stopping means for the slide able stop member 115.

In operation, the bobber is cast upon the water as seen in FIG. 6A. Any trapped air is released through the vent slots. The bobber holds and maintains its vertical position in the water, when the fixed line stop and hook/bait or lure drops into the water to the desired fishing depth, as determined by the slide able stop member as seen in FIG. 6B. The fixed line stop and hook/bait or lure is drawn back up into the shield when the fishing line and rig is retrieved back to the fisherman.

I claim:

1. A fishing bobber comprising; a clear, plastic shield with a diametrically open end and a substantially closed end; side walls tapering upwardly and inwardly from the perimeter of said diametrically open end, said side walls tapering into said substantially closed end of said clear, plastic shield forming a hollow chamber; a tubular stem attached to the center axis of said substantially closed end of said clear, plastic shield, said tubular stem extending outwardly and vertically away from said clear, plastic shield; a fishing line passageway extending through the length of the said tubular stem; a first restricted opening at one end of said fishing line passageway and a second restricted opening at the second end of said fishing line passageway, said second restricted opening being open into said clear, plastic shield; an interchangeable float applied to said tubular stem, said interchangeable float applied circumjacent said tubular stem and apart said clear, plastic shield; a securing member to hold said interchangeable float onto said tubular stem.

2. The fishing bobber of claim 1 further comprising a plurality of vent slots formed through said side walls of said clear, plastic shield; said vents slots extending downwardly from said substantially closed end of said clear, plastic shield and toward said diametrically open end of said clear, plastic shield.

3. The fishing bobber of claim 1 further comprising said clear, plastic shield formed of various sizes and shapes to form a substantially horn, cone, bell or funnel shape.

4. The fishing bobber of claim 1 further comprising said tubular stem made of differing lengths with differing outside and inside diameters.

5. The fishing bobber of claim 1 further comprising a small hole formed through said substantially closed end of said clear, plastic shield.

6. The fishing bobber of claim 1 further comprising said clear, plastic shield being made of clear, colored plastic.

7. The fishing bobber of claim 1 further comprising said tubular stem being made of a rigid material.

8. The fishing bobber of claim 1 further comprising said interchangeable float being manufactured of a buoyant material.

9. The fishing bobber of claim 1 further comprising said interchangeable float comprising various buoyancy.

10. The fishing bobber of claim 1 further comprising said interchangeable float being various sizes, shapes, styles and colors.

11. The fishing bobber of claim 1 further comprising said interchangeable float having a bore through its center axis, said bore being of a diameter the same or larger than that as the outside diameter of said tubular stem.

12. The fishing bobber of claim 1 further comprising said securing member comprising a tubular, flexible sleeve with an inside diameter the same as the outside diameter of said tubular stem, said flexible sleeve having an outside diameter of more than that of the outside diameter of said tubular stem.

13. The fishing bobber of claim 1 further comprising said securing member comprising a rigid stop inserted into said a first restricted opening at said one end of said passageway of said tubular stem, said rigid stop with a passageway through its center most axis, said passageway of said rigid stop in parallel with said fishing line passageway of said tubular stem; an annularly flared flange extending around one end of said passageway of said rigid stop, said annularly flared flange extending beyond the outside diameter of said tubular stem.

14. The fishing bobber of claim 1 further comprising the method of removing said securing member from said tubular stem, removing said interchangeable float from said tubular stem, applying said interchangeable float to said tubular stem and applying said securing member to said tubular stem.

15. The fishing bobber of claim 1 further comprising being used in combination with a fishing rig, said fishing rig comprising a fishing line, a slide able stop member, a fixed stop member, a hook and bait or lure.

16. The fishing rig of claim 15 wherein said slide able stop is attached to said fishing line and located above said fishing bobber of claim 1; the end of said fishing line is inserted into said first restricted opening of said tubular stem of claim 1 or said small hole of claim 5 and fed into said clear, plastic shield of claim 1; said fixed stop member of claim 15 attached to said fishing line and abutted to the inside of said substantially closed end of said clear, plastic shield of claim 1, said hook and bait or lure of claim 15 attached to end of said fishing line of claim 15 and suspended inside said diametrically open end of said clear, plastic shield of claim 1.
